(19) United States
(12) Patent Application Publication
(10) Pub. No.: US 2023/0320463 A1
(43) Pub. Date: Oct. 12, 2023

(54) Safety Harness with Quasi-Crossover Ventral Straps

(71) Applicant: 3M INNOVATIVE PROPERTIES COMPANY, St. Paul, MN (US)

(72) Inventors: Michael T. Weiss, Hastings, MN (US); Stephen D. Shaver, Cottage Grove, MN (US); Nathan W. Safe, Red Wing, MN (US)

(21) Appl. No.: 18/020,699

(22) PCT Filed: Aug. 3, 2021
(86) PCT No.: PCT/IB2021/057096

§ 371 Date: Feb. 10, 2023

Related U.S. Application Data
(60) Provisional application No. 63/070,589, filed on Aug. 26, 2020.

(51) Int. Cl. A44B 11/25; A62B 35/00

(52) U.S. Cl. CPC A44B 11/2519; A62B 35/0037; A62B 35/0031

(57) ABSTRACT

A fall-protection safety harness with first and second ventral straps and with a ventral buckle that is at least generally aligned with a sagittal plane of the user. At the sagittal buckle, a section of the first ventral strap is in overlapping relation with a section of the second ventral strap.

### BACKGROUND

Safety harnesses are often used to reduce the likelihood of a user experiencing a fall, and/or to safely arrest the user in the event of a fall. Such harnesses are often used in combination with one or more of a lanyard, a vertical safety system or ladder climb assist system, a self-retracting lifeline, and other fall-protection equipment.

### SUMMARY

In broad summary, herein is disclosed a fall-protection safety harness with first and second ventral straps and with a ventral buckle that is at least generally aligned with the sagittal plane of the user. At the sagittal buckle, a section of the first ventral strap is in overlapping relation with a section of the second ventral strap. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a rear view of an exemplary fall-protection safety harness equipped with exemplary first and second buckle portions.

FIG. 2 is a front view of an exemplary fall-protection safety harness equipped with exemplary first and second buckle portions, with the harness partially donned by a user and with the first and second buckle portions not yet attached to each other.

FIG. 3 is a front view of the exemplary fall-protection safety harness of FIG. 2, with the first and second buckle portions having been attached to each other to form a ventral buckle.

FIG. 4 is a side-front isolated perspective view of exemplary first and second buckle portions and sections of ventral straps associated therewith, with the buckle portions in the process of being brought together to form a ventral buckle.

FIG. 5 is a side-front isolated perspective view of first and second buckle portions with the ventral straps omitted for clarity.

FIG. 6A is a side-rear perspective view of a various components of an exemplary first buckle portion, with a cover plate of the first buckle portion having been omitted so that other components are visible.

FIG. 6B is a rear plan view of the first buckle portion of FIG. 6A.

FIG. 7 is a top plan view of an exemplary second buckle portion.

FIG. 8 is a cross-sectional top view of exemplary first and second buckle portions attached together to form a ventral buckle.

FIG. 9 is a side view of an exemplary ventral buckle and ventral straps associated therewith.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “first” and “second” may be used in this disclosure, it should be understood that those terms are used in their relative sense only unless otherwise noted. As used herein as a modifier to a property or attribute, the term “generally”, unless otherwise specifically defined, means that the property or attribute would be readily recognizable by a person of ordinary skill but without requiring a high degree of approximation.

The following terminology is defined with respect to a fall-protection safety harness as worn by such a user standing upright. The descriptions of positions, orientations, and so on, of harness components as disclosed herein, including in the claims, are thus with respect to the harness as worn by a user standing upright, unless stated otherwise. However, this terminology is used for clarity of description and does not limit the actual orientation of the harness and components thereof during use in a workplace.

Terms such as vertical, upward and downward, upper, lower, above and below, and like terminology, correspond to conventional directions when the harness is worn by a user who is standing upright. The vertical axis (v) is denoted in various Figures herein. The transverse direction conventionally refers to the conventional right-left (lateral) direction of the user and harness, as indicated by transverse axis (t) in various Figures herein. The term ventral refers to the front side of the user's upper body and to harness portions and components located there; the term dorsal refers to the rear side of the user's upper body and to harness portions and components located there. The dorsal-ventral direction is the direction that extends forward-rearward through the user's body (specifically, through the torso), as indicated by dorsal-ventral axis (d-v) in various Figures herein. (The dorsal-ventral direction will be perpendicular to the vertical axis and the transverse axis.)

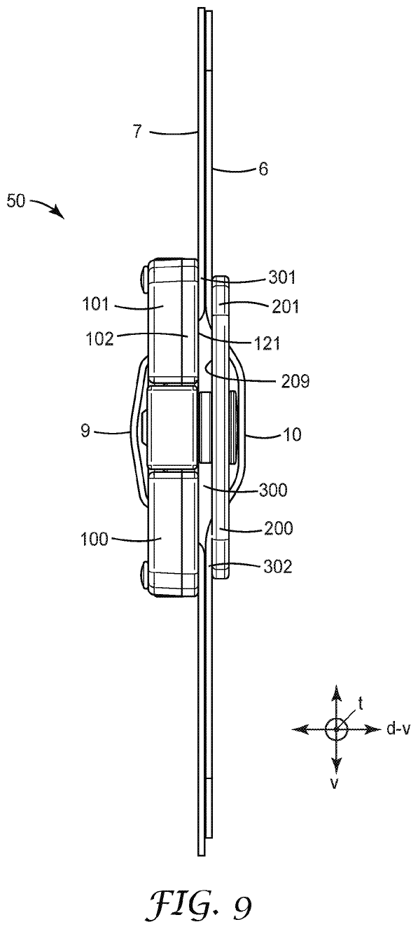

Terms such as inward, unless otherwise specified, denote a direction that is inward toward the user's body along the dorsal-ventral axis; terms such as outward, unless otherwise specified, denote a direction that is outward away from the user's body along the dorsal-ventral axis. Terms such as transversely-inward and transversely-outward are exceptions to this usage; they denote directions respectively toward and away from the sagittal plane of the user's body and of the harness, along the transverse (t). As used herein, the sagittal plane (sometimes referred to as the mid-sagittal plane) has its conventional meaning as a vertical plane that extends down the transverse centerline of the user's body to symmetrically divide the user's body into left and right portions; the term sagittal also applies to the herein-disclosed harness as worn by such a user in an upright position. A sagittal plane is depicted as item 501 in FIG. 9 of U.S. Patent Application Publication 2015/0165246, which is incorporated by reference herein for this purpose.

### DETAILED DESCRIPTION

Fall-protection safety harnesses, sometimes referred to as full-body safety harnesses, are widely used in circumstances in which workers are at elevated height or are otherwise at risk of falling. A fall-protection safety harness is configured to serve in combination with a fall-protection device or apparatus such as, e.g., a self-retracting lifeline, a horizontal lifeline, a lanyard or the like, to provide fall protection. Thus in ordinary use, at least one such fall-protection device is typically connected to the safety harness, e.g., to a D-ring (or other suitable connection point) borne by the harness. Fall-protection safety harnesses will be distinguished from, for example, general-use items such as backpacks and the like.

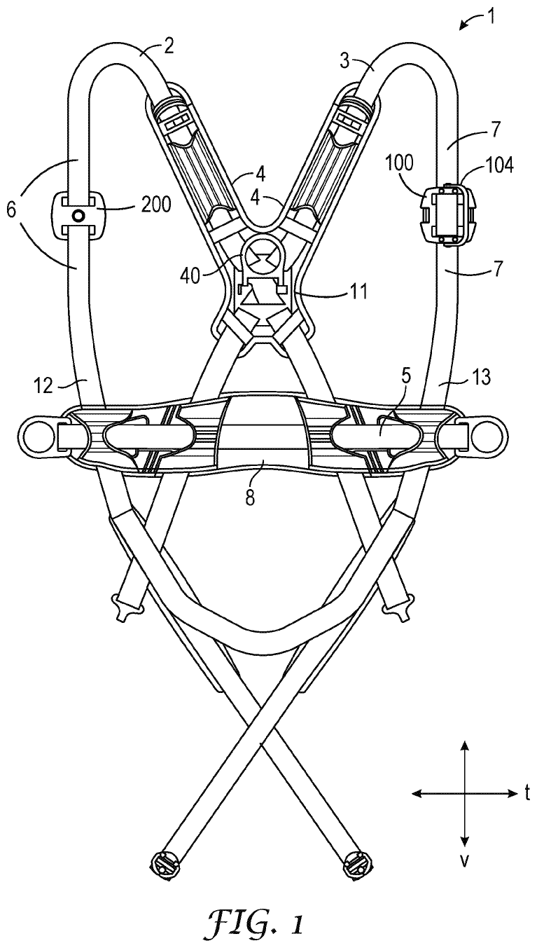

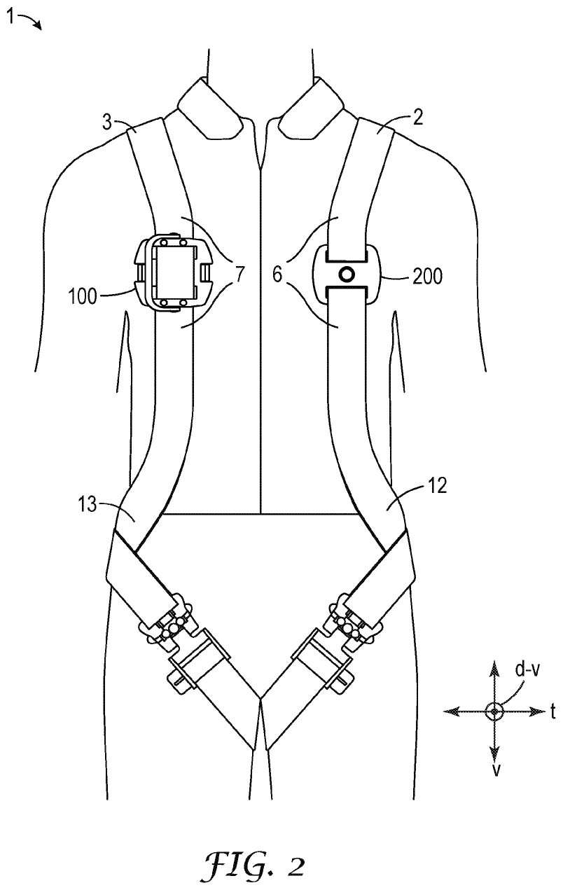

As illustrated in generic representation in FIGS. 1-3, a fall-protection safety harness 1 will comprise an assembly of straps and associated items that can collectively support the weight of a user (wearer) of the harness in the event of a fall. The depictions of FIGS. 1 and 2 are intended as exemplary representations; in actuality a safety harness may vary in some aspects from the particular arrangements shown in these Figures. Also, the exemplary harnesses of FIGS. 1 and 2 differ in various ways and are not to be interpreted as different views of the same harness.

The straps of such a harness are often comprised of flat webbing, made of, e.g., woven synthetic fabric such as, e.g., polyamide, polyaramid (such as, e.g., Kevlar), ultra-high molecular weight polyethylene (such as, e.g., Dyneema) and the like. Such straps are typically flexible so that they can conform to the surface of a wearer's body, can be passed through one or more of buckles, guides, loops and the like, but typically are not significantly extensible. Such straps are interconnected with each other and are often fitted with various pads (e.g., shoulder pads 4 and waist/hip pad 8) to enhance the comfort of the harness, as well as various buckles, latches, connectors, loops, guides, additional pads such as, e.g., chest pads and/or leg pads, and so on. Such components and exemplary arrangements of such components are described in, for example, U.S. Pat. Nos. 8,959,664, 9,174,073, and 10,137,322, all of which are incorporated by reference in their entirety herein.

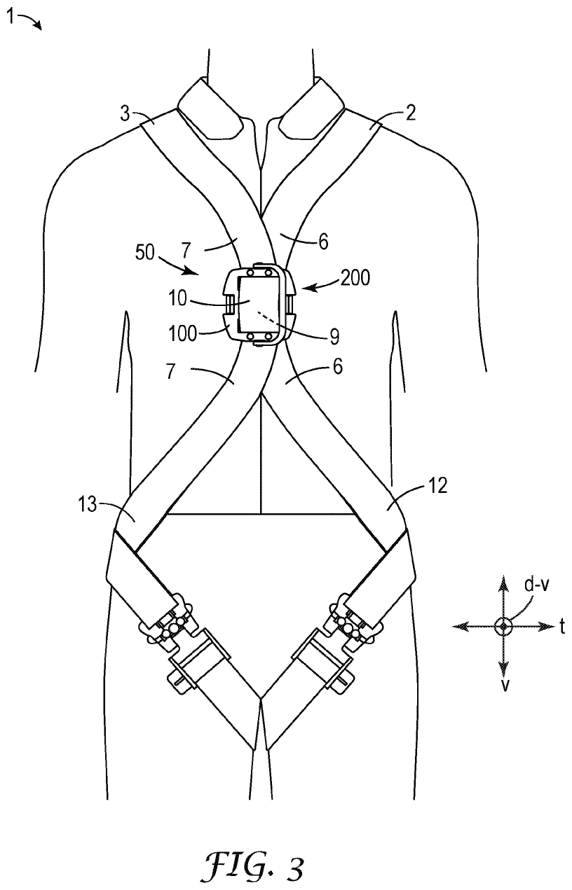

A safety harness 1 typically includes first and second (right and left) straps 3 and 2 that extend over the top of the user's shoulders as shown in FIGS. 2 and 3. FIG. 2 depicts a harness that has been partially donned with first and second buckle portions 100 and 200 not yet having been attached to each other; FIG. 3 depicts such a harness having been fully donned with buckle portions 100 and 200 having been attached to each other to form a ventral buckle 50 as discussed in detail later herein.

On the ventral (front) side of the wearer, shoulder straps 3 and 2 continue generally downward along the wearer's torso as seen in FIGS. 2 and 3 At such locations these straps will be referred to herein as ventral straps 7 and 6 (noting that each ventral strap is often an uninterrupted continuation of a shoulder strap, as evident from FIGS. 1-3). First and second ventral straps 7 and 6 will extend generally downward along the user's torso so that lowermost sections 12 and 13 of straps 7 and 6 will reside at or near the users hips. Often, lowermost sections 12 and 13 of ventral straps 6 and 7 will meet and, e.g., interconnect with a strap 5 (which may be termed a waist strap, hip strap, etc.) that encircles at least a portion of the waist/hip area of the user as shown in FIG. 1. (In various harness designs, a waist strap may or may not be present.) In many embodiments, ventral straps 6 and/or 7 may each be a single piece of webbing that extends continuously from the shoulder to the hip. In other embodiments, a ventral strap 6 and/or 7 may take the form of two individual pieces of webbing that are attached to each other at some location along strap 6 or 7 (by definition, such a location will not be at the ventral buckle). All such design variations are encompassed by the term “strap” as used herein.

In many safety harness designs, the first and second shoulder straps 3 and 2, on the rear (dorsal) side of the wearer's torso, will meet, overlap and cross each other at a dorsal crossing point located, e.g., between the shoulder blades. In some embodiments, a dorsal plate 11 and/or a dorsal pad 4 (which may continue upward to serve as a shoulder pad) may be present, as in the exemplary design of FIG. 1. Often a dorsal D-ring 40 is provided at such a location as shown in FIG. 1. Some safety harnesses, e.g., multipurpose safety harnesses, harnesses specifically configured for use with a vertical or climb assist system, and so on, may comprise a ventral D-ring 104 as illustrated in various Figures herein. (The term D-ring denotes any suitable connecting item, regardless of the exact shape of the item; D-rings may also be provided at other locations, e.g., at the hips, as evident in the exemplary design of FIG. 1.)

In some embodiments, harness 1 will also include leg or thigh straps (shown, unnumbered, in FIGS. 1-3); in various embodiments some such straps may or may not be a continuation of a ventral strap. In some embodiments a fall-protection safety harness may or may not include one or more plates (e.g., a dorsal plate as mentioned above) that may be relatively rigid (e.g., made of molded plastic and/or metal) in comparison to other, relatively flexible harness components such as pads and cushions. Although not shown in the Figures herein, in some embodiments a ventral strap 6 and/or 7 (and/or any other strap, e.g., waist strap, leg strap and so on), may be equipped with a strap adjuster that can be used to adjust the length of the strap as desired. Exemplary strap adjusters are described, e.g., in U.S. Pat. No. 8,794,378. The disclosures herein will make it clear that a ventral buckle as disclosed herein is distinguished from a strap adjuster. A harness as disclosed herein will not necessarily require, and in many embodiments will not include, a coupler strap (i.e., a generally horizontal, transversely-extending strap that extends between left and right chest straps of a conventional H-style harness to each other, as exemplified by item 202 of FIG. 1 of U.S. Pat. No. 9,993,048).

A ventral buckle 50 (and first and second buckle portions 100 and 200 thereof) is an item that is configured specifically for use with body-supporting ventral straps of a fall-protection safety harness. Such a buckle will thus be distinguished from, for example, a buckle that may be used with one or more straps that are used to support the weight only of some relatively lightweight ancillary item (e.g., a hard hat, a tool, etc.) rather than being used with one or more harness straps that must take part in supporting the full weight of a user in the event of a user fall.

Fall-protection safety harnesses have conventionally been of two general types. In one general type of harness, one ventral strap extends from the right shoulder to the right hip of the user, and the other strap extends from the left shoulder to the left hip. Often, such ventral straps descend along the user's torso along a generally vertical, straight path. Such harnesses (which are sometimes referred to as H-style harnesses) conventionally include a coupler strap that extends generally transversely from one ventral strap to the other ventral strap (i.e., that forms the horizontal crossbar of the “H”). Such harnesses have the advantage that they can be donned relatively easily, e.g., in the general manner of a jacket or vest. That is, the ventral straps of such a harness can be forwardly wrapped around the upper torso, after which the chest-strap coupler is used to establish a connection between the two ventral straps.

A second general type of harness is a so-called crossover-style harness. In such a harness, one ventral strap extends from the right shoulder to the left hip, and the other ventral strap extends from the left shoulder to the right hip. (Here and elsewhere, the term shoulder refers to the general region extending from the transverse edge of the neck to the tranversely-outer limit of the deltoid muscle. Similarly, the term hip encompasses the general region from the rectus abdominis muscle to the muscles and tissues laterally overlying the iliac crest). The ventral straps thus cross each other, e.g., in the vicinity of the user's breastbone. Such harnesses can have advantages in redistributing asymmetric forces that may result, e.g., from a heavy tool hanging on a user's hip. Such harnesses can also advantageously position a ventral D-ring near the transverse center of the user's torso (the sagittal plane), which can be particularly advantageous for female users and/or when the harness is used in combination with a vertical safety system, climbing-assist system, or the like. This can be achieved while advantageously having the D-ring directly connected to ventral straps rather than being connected to an above-described coupler strap. However, a crossover-style harness has the disadvantage that the harness cannot be donned like a jacket or vest. Rather, the harness must be pulled downward over the user's head in the general manner of a pullover sweater. This can be cumbersome, particularly for a novice user of the harness, and can lead to a momentarily confusing tangle of straps.

Quasi-crossover Design

The present design is a quasi-crossover design which preserves the advantages of both types of harnesses. By definition, a quasi-crossover design denotes an arrangement in which a first ventral strap 7 of the harness extends from the right shoulder of the user to the right hip of the user, and a second ventral strap 6 of the harness extends from the left shoulder of the user to the left hip of the user, as in an H-style harness. However, each ventral strap does not extend generally straight vertically downward along the user's torso in the usual manner of an H-style harness. Instead, each ventral strap, as it extends downward from the user's shoulder, deviates transversely inwardly (toward the sagittal plane of the user and harness) so that the ventral straps meet each other a ventral buckle 50 in the general manner shown in FIG. 3. Then, as each ventral strap continues downward from the ventral buckle, it deviates transversely outward so that it extends to the hip that is on the same side as the shoulder from which the ventral strap originated, as evident in FIG. 3.

In some embodiments, this can be achieved by mounting a first buckle portion 100 on first ventral strap 7, and by mounting a second buckle portion 200 on second ventral strap 6, as shown in FIG. 2. When donning the harness, the two buckle portions 100 and 200 can be moved transversely inward toward each other (and toward the sagittal plane of the user) so that the two buckle portions are in overlapping relation with each other. The buckle portions can then be fastened together to form buckle 50. It will be appreciated that this can be performed in generally similar manner to the donning of an H-style harness rather than the harness having to be pulled downward over the user's head.

In a quasi-crossover design, the ventral buckle 50 will be at least generally aligned with the sagittal plane of the user and of the harness, as is evident from FIG. 3. By this is meant that the ventral buckle will be at least generally centered with respect to the right-left (transverse) axis of the user and harness, so that the sagittal plane passes through at least some portion of the buckle. Often, the sagittal plane may pass near, or very close to, the transverse center of the buckle. In a quasi-crossover design, another condition will be met—a section of the first ventral strap 7 that extends through the first buckle portion 100 of the ventral buckle 50 will be in overlapping relation with a section of the second ventral strap 6 that extends through the second buckle portion 200 of the ventral buckle 50. This condition is also evident in FIG. 3, in which section 10 of first ventral strap 7 is in overlapping relation with section 9 of second ventral strap 6.

By overlapping relation is meant that a line that passes through at least some part of one ventral strap, along a dorsal-ventral direction, will also pass through at least some part of the other ventral strap. Typically, with the strap sections in overlapping relation, the left terminal edge of one of the ventral straps will be positioned leftward (along the transverse direction) of the right terminal edge of the other ventral strap; and, the right terminal edge of the other ventral strap will be positioned rightward of the left terminal strap of the first ventral strap as is again evident from FIG. 3.

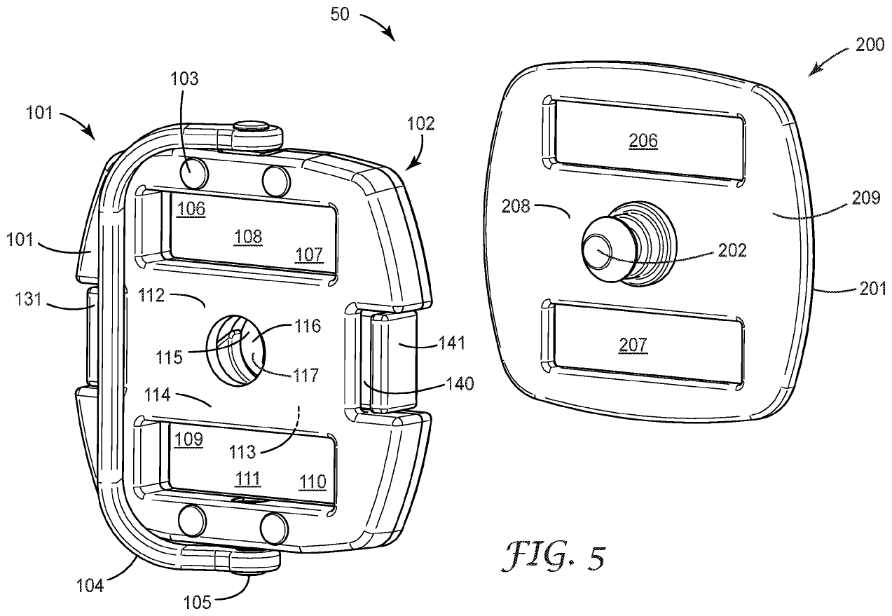

A configuration in which the ventral straps are in overlapping relation may be dictated by the path that the ventral straps are required to follow as they pass through various slots, guides, or the like, in the buckle portions. In particular embodiments, sections of the ventral straps that are located between upper and lower strap-guiding slots of the buckle portions (e.g., slots 108, 111, 206 and 207, as shown in FIG. 5 and as discussed in detail later herein) may be guided into such an arrangement. In some embodiments a section of the first ventral strap that extends between the upper and lower slots of the first buckle portion may be aligned with a section of the second ventral strap that extends between the upper and lower slots of the second buckle portion. By aligned with is meant that at least over a short vertical distance, the centerline of the first ventral strap and the centerline of the second ventral strap at least generally coincide, e.g., in the general manner evident in FIG. 3. In many embodiments, the centerline of both ventral straps may coincide with the sagittal plane, also as evident in the exemplary arrangement of FIG. 3.

Exemplary buckle designs that may achieve the above-described effects are depicted in FIGS. 5-8. In some exemplary embodiments a ventral buckle 50 may be provided in the form of two buckle portions 100 and 200, which can be attached to each other to form buckle 50. In some embodiments, first buckle portion 100 may comprise a base plate 101 and a cover plate 102 that are permanently attached to each other, e.g., by mechanical fasteners, e.g., metal rivets 103.

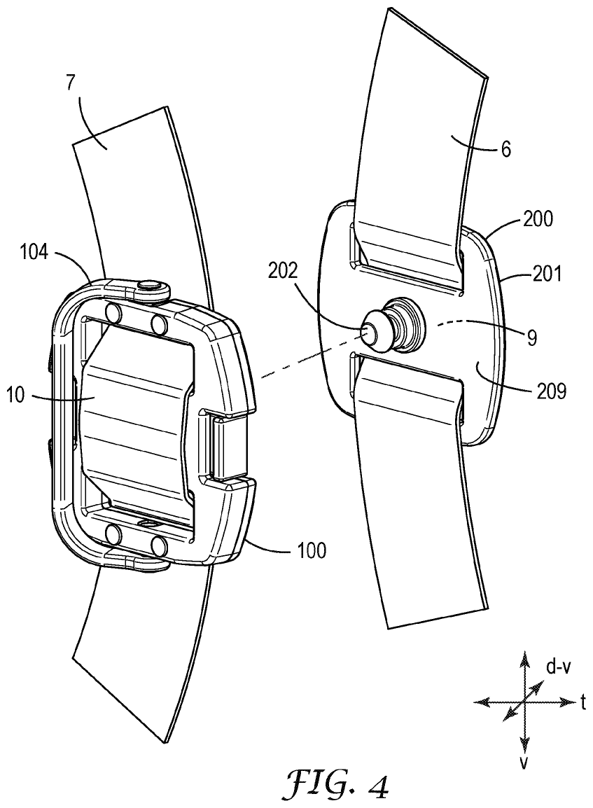

In some embodiments, a base plate 101 of a first buckle portion 100 may comprise upper and lower transversely-extending slots 106 and 109 (as noted, this upper and lower terminology is with reference to buckle 50 as present in a harness worn by a vertically upright user). A cover plate 102 of the first buckle portion 100 may similarly comprise upper and lower transversely-extending slots 107 and 110. When base plate 101 and cover plate 102 are attached to each other in the factory to form first buckle portion 100, slots 106 and 107 may align to collectively form a transversely-extending upper slot 108 of first buckle portion 100 and slots 109 and 110 may align to collectively form a transversely-extending lower slot 111 of first buckle portion 100, all as shown in FIG. 5. Slots 108 and 111 of first buckle portion 100 will be configured to allow first ventral strap 7 to pass therethrough in the manner illustrated in FIG. 4. In between the upper and lower transversely-extending slots 108 and 111 may be a central crossbar 114, respectively provided, e.g., by crossbar portions 112 and/or 113 of base plate 101 and cover plate 102.

As discussed in detail below, first buckle portion 100 may be used in combination with, i.e., attached to, second buckle portion 200 to form ventral buckle 50. In some embodiments, second buckle portion 200 may comprise a base 201 with an upper, transversely-extending slot 206 and a lower, transversely-extending slot 207 as seen, e.g., in FIG. 5, with slots 206 and 207 being configured to allow second ventral strap 6 to pass therethrough as seen in FIG. 4.

In some embodiments, buckle portions 100 and 200 may be configured so that upper slot 108 of first buckle portion 100 is in at least partial overlapping relation with upper slot 206 of second buckle portion 200; similarly, lower slot 111 of first buckle portion 100 may be in at least partial overlapping relation with lower slot 207 of second buckle portion 200, as evident in the exemplary designs pictured in FIGS. 3, 4 and 9. However, in many such embodiments, first ventral strap 7 that passes through slots 108 and/or 111 of first buckle portion 100 will not pass through slot 206 or slot 207 of second buckle portion 200. Similarly, second ventral strap 6 that passes through slots 206 and 207 of second buckle portion 200 will not pass through slot 108 or slot 111 of first buckle portion 100. That is, in such embodiments each buckle portion receives and guides only a single ventral strap; and, the buckle portions are attached to each other only by a mechanical connection between the buckle portions themselves (as discussed in detail below) rather than being held together to each other by any action of the ventral straps.

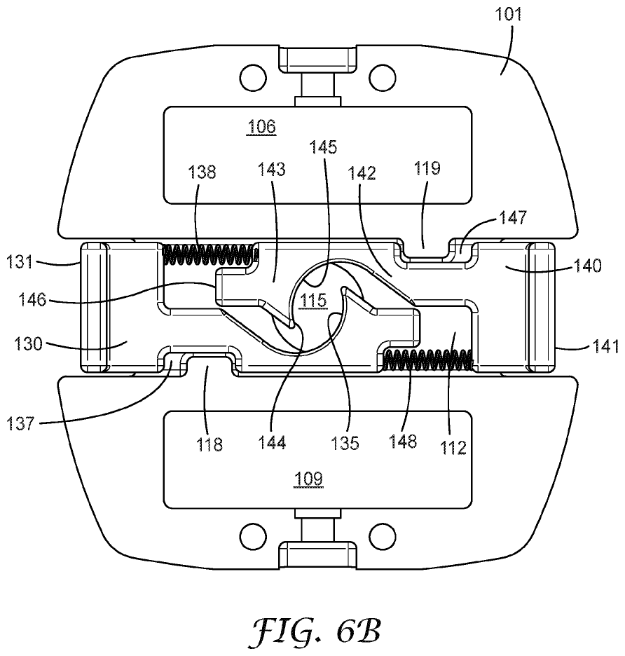

In some embodiments, base plate 101 and cover plate 102 may respectively comprise through-openings 115 and 116, which (along with an air gap which may be present therebetween) are aligned so as to define a receiving aperture 117 of first buckle portion 100, as shown in FIG. 5. Receiving aperture 117 is configured to receive a post 202 of a second buckle portion 200 as discussed in detail below. Second buckle portion 200 (as seen in perspective view in FIG. 5 and in side view in FIG. 7) may further comprise a base 201 from which post 202 protrudes. Post 202 of second buckle portion 200 is configured to enter receiving aperture 117 of first buckle portion 100 and to be securely held therein, in order to attach first and second buckle portions 100 and 200 to each other to form ventral buckle 50. The various components of first and second buckle portions 100 and 200 (e.g., base plate, cover plate, post, and so on) may be made of any suitable material, e.g., a metal such as aluminum or steel. Stainless steel may be particularly preferable in some embodiments.

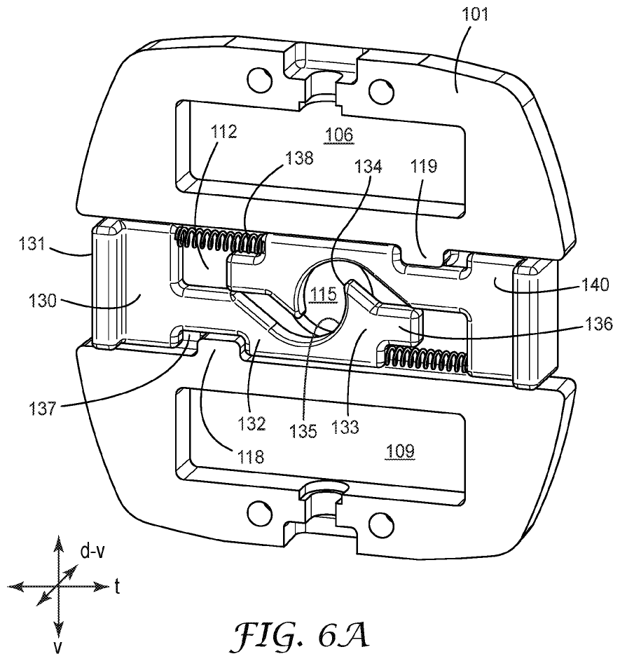

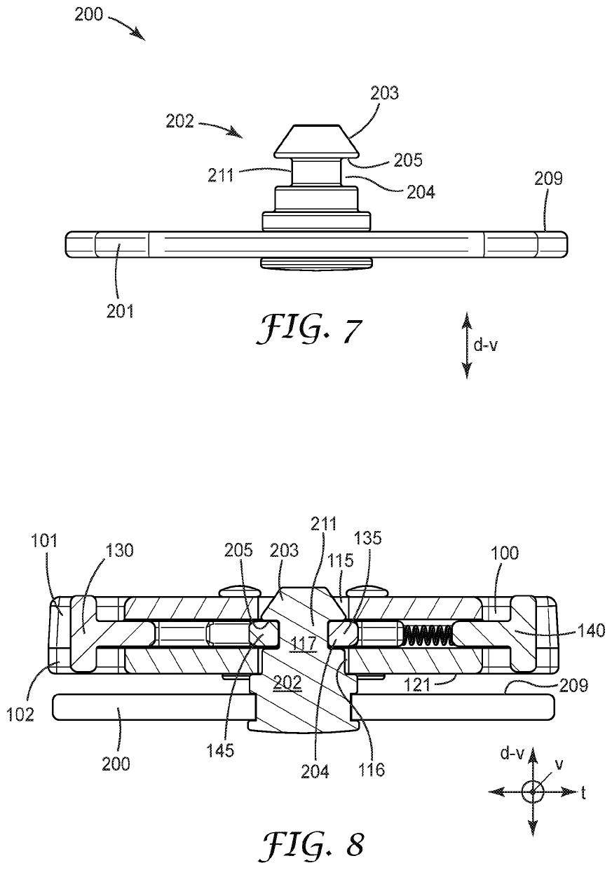

In some embodiments, first buckle portion 100 may comprise one, two, or more latches, e.g., sliding latches, that serve to hold post 202 of second buckle portion 200 securely in place in receiving aperture 117 of first buckle portion 100 in order to attach the first and second buckle portions together to form ventral buckle 50. In the general arrangement seen, e.g., in FIGS. 6A and 6B (which are rear views of first buckle portion 100 with cover plate 102 omitted so that other components can be seen), two such sliding latches 130 and 140 are used. Latches 130 and 140 are slidably movable between a first, unlatched position that allows the post 202 of second buckle portion 200 to enter and exit the receiving aperture 117 of first buckle portion 100; and, a second, latched position which securely retains post 202 in aperture 117. In some embodiments, first latch 130 may comprise an exposed flange 131 (that is accessible to be pushed laterally inwards by the finger(s) of a user), a shaft 132, and a head 133 that comprises a collar portion 135 that terminates in a barb 134. Second latch 140 may similarly comprise an exposed flange 141 for manual actuation, a shaft 142, and a head 143 that comprises a collar portion 145 that terminates in a barb 144. When the first and second latches are in the second, latched position, collar portions 135 and 145 will collectively form a partial collar that resides in a gap 204 located inward of an outward head 203 of post 202 of second buckle portion 200. The partial collar will thus partially encircle the narrow “shank” 211 of post 202. (Post 202, head 203, gap 204, and shank 211 of second buckle portion 200 are most easily seen in FIG. 7; a side cross-sectional view of the sliding latches and post, in the second, latched position, is provided in FIG. 8.) This can securely hold post 202 of the second buckle portion 200 in place in the receiving aperture 117 of the first buckle portion 100 so that first and second buckle portions 100 are held together to form ventral buckle 50.

A useful design parameter is the extent to which collar portions 135 and 145 of sliding latches 130 and 140 circumferentially “wrap around” to form barbs 134 and 144. This can dictate the extent to which the partial collar that is collectively provided by collar portions 135 and 145, will encircle the shank 211 of post 202 that is captured therein when the latches are in the second, latched position. In various embodiments, each collar portion 135 and 145 may exhibit a wrap angle of from 5, 10, 15, or 20 degrees, to 45, 35 or 25 degrees. The wrap angle is measured quantitatively as the angle to which the collar portion wraps (extends) past the lateral axis (which extends left-right in FIG. 6B) of the slider portion to form the tip of barb 134 or 144. of the buckle. This wrap angle is measured from an origin that is the center of a circle that is best-fit to be locally coincident with (i.e., that is locally superimposed on) the arc that is defined by the collar portion. (By way of specific examples, the exemplary collar portions 135 and 145 depicted in FIG. 6B each exhibit a wrap angle of approximately 20 degrees.)

In some embodiments, first and second sliding latches 130 and 140 of first buckle portion 100 may be biased toward the second, latched position. This may be achieved by the use of any suitable biasing member or members that can exert an appropriate biasing force. As shown in exemplary depiction in FIGS. 6A and 6B, in some embodiments such an arrangement may rely on two biasing springs (in this case, coil springs, installed in a compressed condition) 138 and 148. As evident from these Figures, each spring acts to urge sliding latches 130 and 140 in directions that cause collar portions 135 and 145 to move laterally inward, toward each other. In other words, the biasing springs urge the latches to slidably move so that collar portions 135 and 145 are moved into a second, latched position in which they collectively form the partial collar as described above.

The biasing force of springs 138 and 148 can be overcome by a user manually applying laterally inward force to portions 131 and 141 of sliding latches 130 and 140, which will move collar portions 135 and 145 laterally outward, away from each other, into a first, unlatched position. With the collar portions (and sliding latches 130 and 140 as a whole) in the first, unlatched position, the collar portions do not interfere with removing post 202 of second buckle portion 200 from the receiving aperture 117 of the first buckle portion.

Thus in summary, the first and second sliding latches of first buckle portion 100 are configured so that they can be manually slidably moved from the second, latched position, into the first, unlatched position in order to detach first and second buckle portions 100 and 200 from each other (e.g., when the user desires to remove the harness). In the depicted embodiment, this can be performed by manually squeezing exposed ends 131 and 141 of first and second sliding latches 130 and 140 transversely inward, toward each other.

In the illustrated embodiment, biasing members 138 and 148 are coil springs that are positioned in compression in spaces between first and second sliding latches 130 and 140. In some embodiments abutments 136 and 146 (as seen, e.g., in FIGS. 6A and 6B) may extend from head 133 and 143 of sliding latches 130 and 140; such abutments (or any similar structure) may assist in keeping biasing members 138 and 148 in their designated positions. It will be appreciated that any suitable biasing member may be used, of any type, in any suitable location. Such a member does not necessarily have to be mounted in compression and does not have to be positioned as shown in the Figures herein. For example, a coil spring might be installed in tension. Or, a spring that is used as a biasing member need not necessarily be a coil spring but could rather be a torsion spring, a leaf spring or any other design.

In some embodiments, post 202 of second buckle portion 200 may comprise an outward head 203 that is tapered as seen in FIG. 7 (that is, head 203 has a smaller diameter at its outward, distal end). In such an arrangement, the act of moving the first and second buckle portions 100 and 200 toward each other (along a dorsal-ventral axis) to attach the first and second buckle portions to each other, causes the tapered outward head 203 of post 202 to enter receiving aperture 117 and to impinge on collar portions 135 and 145 of first and second sliding latches 130 and 140. Continued movement of head 203 into receiving aperture 117, in combination with the taper of head 203, will cause head 203 to force collar portions 135 and 145 away from each other (overcoming the above-described biasing force) and thus will slidably urge the first and second sliding latches into the first, unlatched position to allow post 202 to enter receiving aperture 117. Further movement of post 202 into receiving aperture 117 will have the result that the outward head 203 of post 202 will move outward past the collar portions 135 and 145 of the first and second sliding latches. The biasing force of springs 138 and 148 will then urge the first and second sliding latches to automatically slidably move into the second, latched position, in which the collar portions 135 and 145 of the latches have moved toward each other to collectively form the above-mentioned partial collar. This partial collar will reside in the gap 204, inward of the inward surface 205 of the tapered outward head 203 of post 202, and will encircle the shank 211 of the post, as shown in FIG. 8.

Based on the discussions above it will be appreciated that the engaging of the post of the second buckle portion with the sliding latches of the first buckle portion can occur automatically upon insertion of the post into the receiving aperture of the first buckle portion. That is, no manipulation of the sliding latches by the fingers of the user is required in order to attach the first and second buckle portions to each other to form the ventral buckle.

In contrast, in the depicted embodiment the disengaging of the post from the sliding latches to detach the buckle portions from each other requires deliberate manual actuation. That is, a preliminary step of manually moving the sliding latches to an unlatched position must be performed before the post can be removed from the receiving aperture. Thus in at least some embodiments, the first and second buckle portions can be automatically attached to each other as a consequence of moving the buckle portions toward each other so that the post enters the receiving aperture; while, in contrast, a preliminary step of slidably moving the latches to unlatch them must be performed in order to move the buckle portions away from each other so as to detach them from each other.

It will thus be evident that when the buckle portions 100 and 200 are separated from each other (e.g., when the harness is not being worn by a user) the biasing force of the biasing members will cause the sliding latches to be held in their second, latched position (although no post will be present to be secured in the receiving aperture). To don the harness, the upper portions of the harness are wrapped forwardly about the shoulders and the right and left ventral straps are positioned on right and left sides of the upper torso. The first and second buckle portions are then moved transversely inward toward the sagittal plane of the user, and are positioned with the first buckle portion outward (forward, along the dorsal-ventral axis) of the second buckle portion. The buckle portions are then moved toward each other along the dorsal-ventral axis so that the post of the second buckle portion enters the receiving aperture of the first buckle portion. This will overcome the biasing force and will cause the sliding latches to momentarily move to the first, unlatched position to allow the post to be captured, and the buckle portions attached to each other, as described above. In this capturing process, the latches will automatically return to the second, latched position under the influence of the biasing force.

When the harness is to be removed, the user will manually manipulate the sliding latches to the first, unlatched position, and will then move the first and second buckle portions apart in an inward-outward direction along the dorsal-ventral axis. It will be appreciated that movement of the first and second buckle portions generally along a dorsal-ventral axis to attach or detach the buckle portions to/from each other, is contrast to buckles that are engaged and disengaged via motion in some other direction, e.g., motion along the transverse axis or vertical axis.

In some embodiments, the base plate 101 and/or the cover plate 102 of first buckle portion 100 may comprise at least one feature that limits the extent of the transversely outward movement of the first sliding latch; the plate(s) may similarly comprise at least one feature that limits the extent of the transversely outward movement of the second sliding latch. For example, in the exemplary arrangements depicted in FIG. 6B, base plate 101 comprises tabs 118 and 119 that protrude into elongate notches 137 and 147 of first and second sliding latches 130 and 140. This can limit the range of motion of the sliding latches to a desired extent and in particular can prevent the latches from sliding so far transversely outward that they might, e.g., become dislodged from the buckle or protrude obtrusively.

In some embodiments first and second buckle portions 100 and 200 may be configured so that when they are attached to each other, they are able to pivot with respect to each other to some extent, e.g., through an angle of relative rotation of at least 5, 10 or 20 degrees, up, e.g., to 30 or 40 degrees or more. In some embodiments, the first and second buckle portions are unable to rotate relative to each other, through an angle of more than 15, 7 or 3 degrees. It will be appreciated even if the buckle portions do not have any feature that purposefully limits the rotation of the portions, the action of the ventral straps will typically keep the buckle portions closely aligned with each other.

A feature of at least some of the embodiments disclosed herein is that when first and second buckle portions 100 and 200 are detached from each other, first buckle portion 100 can be slidably moved along first ventral strap 7, and second buckle portion 200 can similarly be slidably moved along second ventral strap 6. In other words, when buckle portions 100 and 200 are in the general configuration shown in FIGS. 2 and 4, the user can slide each buckle portion upward or downward in a generally vertical direction, as desired. (The serpentine route that the ventral straps follow through the buckle portions will typically cause enough frictional resistance that the buckle portions will not slide freely along the straps but rather will remain in place until deliberately moved by a user.) When both buckle portions are in the desired position, they can then be attached to each other. The upward/downward location of buckle 50 can thus be chosen as desired, e.g., to provide the best fit to the particular body shape of a user.

After first and second buckle portions 100 and 200 are attached to each other to form ventral buckle 50 (e.g., as shown in FIG. 2), sections of first and second straps 7 and 6 will be pinched together (along a dorsal-ventral direction) between first and second buckle portions 100 and 200. This may occur, for example, at pinch points 301 and 302 as indicated in the side view of FIG. 9. For example, sections of straps 6 and 7 may be pinched between portions of inward major surface of 121 of cover plate 102 of first buckle portion 100, and portions of outward major surface 209 of base 201 of second buckle portion 200, as in FIG. 9. Such arrangements may be achieved, e.g., by designing the width of gap 300 between surfaces 121 and 209 in view of the combined thickness of ventral straps 6 and 7, at least at locations where the desired pinching is to take place.

This pinching action can have the result that movement of ventral buckle 50 along ventral straps 6 and 7 is substantially prevented. By this it is meant that relatively small forces as may occur during normal work activities (e.g., the tugging action of a climb-assist system) will not cause the ventral buckle to slide along the ventral straps a significant amount. (However, in the event of a fall, some small sliding movement of the buckle may occur.) This pinching action may also have the result that the two ventral straps are not able to move significantly relative to each other. This can have the effect that any forces that one ventral strap is exposed to may be transferred to the other ventral strap to at least some extent. Thus, for example, the load from the weight of a heavy tool on a user's hip may be more evenly distributed over the right and left shoulders. In this manner, the herein-disclosed quasi-crossover arrangement of ventral straps can achieve many of the advantages of a true crossover harness, while still being able to be easily donned in the manner of a conventional H-style harness.

As noted, in many embodiments first and second buckle portions 100 and 200 and components thereof, may be made of any suitable material. In some embodiments, any such component may be made of any suitable metal, e.g., steel or aluminum. In various embodiments, such a component may be a forged body or a cast body; or, it may be made of sheet metal that is formed (e.g., bent) into the desired shape using standard sheet metal forming techniques. Typically base plate 101 and cover plate 102 may be manufactured separately and then brought together (with the sliding latches, springs, etc. captured therebetween) and attached to each other, e.g., by rivets 103, to form first buckle portion 100. Base 201 and post 202 may be made separately and then attached to each other to form second buckle portion 200; or, base 201 and post 202 may be integral with each other.

In some embodiments some part of a buckle portion and/or a sliding latch thereof, (in particular, any areas that are to be regularly contacted by the fingers of a user) may be partially encased in an overmolded organic polymeric resin. Overmolding can be performed, e.g., by taking a previously-formed metal body and inserting it at least partially into an injection-molding cavity so that an organic polymeric molding resin can be formed atop, and adhered to, the desired portions of the body.

It will be understood that the particular designs of the buckle portions presented herein are exemplary and that variations may be present but which may still allow buckle portions to form a ventral buckle that achieves a quasi-crossover arrangement of straps.

A ventral buckle as disclosed herein (and a quasi-crossover arrangement of ventral straps) can be used with any suitable fall-protection harness. Such harnesses are well known and may be used with a wide variety of fall-protection apparatus, methods and systems. In some embodiments, the fall-protection harness, and the ventral buckle thereof, may meet the requirements of ANSI Z359.12.

Fall-protection apparatus and systems (e.g., lanyards, self-retracting lifelines, positioning systems, horizontal systems, vertical systems, climb-assist systems, descenders, etc.), fall-protection anchorages, components of such apparatus, systems, equipment, and so on, with which the arrangements disclosed herein may find use, are described, e.g., in the 3M DBI-SALA Fall Protection Full Line Catalog 2018.

It is emphasized that a user of any fall-protection device, apparatus, system, or component thereof that includes a harness and/or ventral buckle as described herein is tasked with carrying out any appropriate steps, actions, precautions, operating procedures, etc., as required by applicable laws, rules, codes, standards, and/or instructions. That is, under no circumstances will the presence of any arrangement disclosed herein relieve a user of the duty to follow all appropriate laws; rules; codes; standards as promulgated by applicable bodies (e.g., ANSI); instructions as provided by the manufacturer of the fall-protection system, apparatus or components; instructions as provided by the entity in charge of a worksite, and so on.

While the disclosed buckles herein are discussed herein primarily in the context of being used as a ventral buckle for use with ventral straps of a fall-protection safety harness, in various embodiments such buckles could be used with other straps of a fall-protection safety harness, with straps of a general-purpose harness, or, with straps for any desired purpose.

In summary, all such variations and combinations are contemplated as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein but to which no priority is claimed, this specification as written will control.

1. A fall-protection safety harness configured so that when the harness is worn by a user, a first ventral strap of the harness extends from the right shoulder of the user to the right hip of the user and a second ventral strap of the harness extends from the left shoulder of the user to the left hip of the user,
wherein a first buckle portion is mounted on the first ventral strap and a second buckle portion is mounted on the second ventral strap, the first and second buckle portions being detachably attached to each other to form a ventral buckle; and,
wherein the first and second ventral straps and the first and second buckle portions are configured so that the ventral buckle is at least generally aligned with a sagittal plane of the user and so that a section of the first ventral strap that extends through the first buckle portion is in overlapping relation with a section of the second ventral strap that extends through the second buckle portion.

2. The fall-protection safety harness of claim 1 wherein when the first and second buckle portions are detached from each other, the first buckle portion is slidably movable along the first ventral strap and the second buckle portion is slidably movable along the second ventral strap, and wherein when the first and second buckle portions are attached to each other to form the ventral buckle, the first and second ventral straps are pinched together between the first and second buckle portions so that movement of the ventral buckle along the first and second ventral straps is substantially prevented.

3. The fall-protection safety harness of claim 1 wherein the first buckle portion of the ventral buckle is positioned outward, along a dorsal-ventral axis of the harness, from the second buckle portion of the ventral buckle; wherein a process of detaching the first and second buckle portions from each other includes an act of moving the first and second buckle portions apart along the dorsal-ventral axis; and, wherein a process of reattaching the first and second buckle portions to each other comprises an act of moving the first and second buckle portions toward each other along the dorsal-ventral axis.

4. The fall-protection safety harness of claim 1 wherein the first buckle portion comprises a base plate and a cover plate that are permanently attached to each other; wherein at least one of the base plate and the cover plate comprises upper and lower, transversely-extending slots that define upper and lower, transversely-extending slots of the first buckle portion; and, wherein at least one of the base plate and the cover plate comprises a receiving aperture configured to receive a post of the second buckle portion.

5. The fall-protection safety harness of claim 4 wherein the base plate and cover plate of the first buckle portion are each made of metal and wherein the base plate and cover plate are separately-made parts that are joined together by multiple fasteners, and wherein the base plate and the cover plate each comprise a through-opening, which through-openings are aligned with each other and which collectively define the receiving aperture of the first buckle portion.

6. The fall-protection safety harness claim 4 wherein the second buckle portion comprises a base plate and a post permanently attached thereto and protruding therefrom, and wherein the post is configured to enter the receiving aperture of the first buckle portion and to be held therein, in order to attach the first and second buckle portions together to form the ventral buckle.

7. The fall-protection safety harness of claim 6 wherein the base plate and the post of the second buckle portion are each made of steel.

8. The fall-protection safety harness of claim 6 wherein the first buckle portion comprises first and second sliding latches that are slidably movable between a first, unlatched position that allows the post of the second buckle portion to enter and exit the receiving aperture of the first buckle portion; and, a second, latched position, in which collar portions of the first and second sliding latches collectively form a partial collar that resides in a gap inward of a tapered outward head of the post to hold the post in place in the receiving aperture of the first buckle portion so as to hold the first and second buckle portions together.

9. The fall-protection safety harness of claim 8 wherein the collar portion of the first sliding latch, and the collar portion of the second sliding latch, each exhibit a wrap angle of from 10 degrees to 40 degrees.

10. The fall-protection safety harness of claim 8 wherein the first and second sliding latches of the first buckle portion are biased toward the second, latched position, and wherein the first and second sliding latches of the first buckle portion are configured so that they can be manually slidably moved from the second, latched position, into the first, unlatched position.

11. The fall-protection safety harness of claim 10 wherein the post of the second buckle portion and the first and second sliding latches of the first buckle portion are configured so that moving the first and second buckle portions toward each other along a dorsal-ventral axis to attach the first and second buckle portions to each other, causes the tapered outward head of the post to impinge on the collar portions to overcome the biasing force and slidably urge the first and second sliding latches into the first, unlatched position to allow the post to enter the receiving aperture.

12. The fall-protection safety harness of claim 11 wherein the post of the second buckle portion and the first and second sliding latches of the first buckle portion are configured so that entry of the post into the receiving aperture of the first buckle portion causes the tapered outward head of the post to move sufficiently far outward past the collar portions of the first and second sliding latches that the biasing force urges the first and second sliding latches to automatically slidably move into the second, latched position in which the collar portions of the first and second sliding latches collectively form the partial collar that resides in the gap inward of the tapered outward head of the post of the second buckle portion.

13. The fall-protection safety harness of claim 10 wherein the first and second sliding latches are configured so that they can be manually actuated from the second, latched position into the first, unlatched position, by manually squeezing exposed opposite ends of the first and second sliding latches transversely inward, toward each other.

14. The fall-protection safety harness of claim 10 wherein the biasing force is provided by first and second biasing members that are each configured and positioned to urge opposing ends of the first and second sliding latches to slidably move transversely outward away from each other, and to urge the portions of the first and second sliding latches that collectively form the partial collar, to slidably move toward each other to form the partial collar.

15. The fall-protection safety harness of claim 8 wherein the base plate and/or the cover plate of the first buckle portion comprises at least one feature that limits an extent of slidable transversely outward movement of a transversely outward end of the first sliding latch and at least one feature that limits an extent of slidable transversely outward movement of a transversely outward end of the second sliding latch.

16. The fall-protection safety harness of claim 15 wherein the at least one feature is a tab that protrudes into a transversely-elongate slot in the sliding latch.

17. The fall-protection safety harness of claim 1 wherein the first buckle portion comprises upper and lower, transversely-extending slots through which the first ventral strap passes, wherein the second buckle portion comprises upper and lower, transversely-extending slots through which the second ventral strap passes, and wherein a section of the first ventral strap that extends between the upper and lower slots of the first buckle portion is in overlapping relation with, and is aligned with, a section of the second ventral strap that extends between the upper and lower slots of the second buckle portion.

18. The fall-protection safety harness of claim 17 wherein the upper, transversely extending slot of the first buckle portion is in at least partial overlapping relation with the upper, transversely extending slot of the second buckle portion; and, wherein the lower, transversely extending slot of the first buckle portion is in at least partial overlapping relation with the lower, transversely-extending slot of the second buckle portion; and further wherein no ventral strap that passes through a slot of the first buckle portion passes through a slot of the second buckle portion and no ventral strap that passes through a slot of the second buckle portion passes through a slot of the first buckle portion.

19. The fall-protection harness of claim 1 wherein the harness, and the ventral buckle, meet the requirements of ANSI Z359.12.

20. A method of donning the fall-protection safety harness of claim 1, the method comprising wrapping an upper portion of the safety harness about the shoulders and upper torso of the user in the manner of a jacket and then attaching the first and second buckle portions to each other to form the ventral buckle, wherein the method does not require any step of pulling the harness downward over the heat and shoulders of the user in the manner of a pullover sweater.
